(19) United States
(12) Patent Application Publication
(10) Pub. No.: US 2026/0253344 A1
(43) Pub. Date: Aug. 27, 2026

(54) INFRASTRUCTURE TO VIRTUALLY REPRESENT A RETAIL STORE

(71) Applicant: Dell Products L.P., Round Rock, TX (US)

(72) Inventors: Michael Robillard, Shrewsbury, MA (US); Rushiv Arora, Boston, MA (US); Karim Elghamry, Co. Cork (IE)

(21) Appl. No.: 19/066,027

(22) Filed: Feb. 27, 2025

(51) Int. Cl. G06T 19/00; G06T 7/80

(52) U.S. Cl. CPC G06T 19/006; G06T 7/80; G06T 2200/08

(57) ABSTRACT

One example method includes using cameras to map a physical space, calibrating the cameras, based on movement of a human or other entity in the physical space, obtaining camera location and orientation information, creating, using a digital twin of the physical space and the camera location and orientation information, a virtual reality environment that includes virtual representations of the cameras that are located and oriented in the same way as in the physical space, collecting, from the virtual reality environment, data collected by the cameras, and processing the data.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to virtual reality (VR) environments. More particularly, at least some embodiments relate to systems, hardware, software, computer-readable media, and methods, for creating and using virtual representations of various physical environments including, but not limited to, retail stores.

### BACKGROUND

In the present era of so-called ‘big data,’ the relentless advancement of technology has led to the proliferation of multiple sensors that continuously gather vast amounts of information, both day and night. The data from these sensors can be fed to AI/ML (artificial intelligence/machine learning) models, which often require a model, or a ‘gym,’ to train and operate in to generate actionable information which in turn would lead to business transformation in the modern AI industrial revolution. However, irrespective of the context—smart cities, autonomous vehicles, or industrial processes—the data collected is often too extensive to manage effectively using conventional approaches.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1a discloses aspects of an example infrastructure, according to one embodiment.

FIG. 1b discloses aspects of an example architecture, according to one embodiment.

FIG. 1c discloses aspects of an example schema, according to one embodiment.

FIG. 2 discloses aspects of a method, according to one embodiment.

FIG. 3 discloses aspects of a computing entity configured and operable to perform any of the disclosed methods, processes, and operations.

### DETAILED DESCRIPTION OF SOME EXAMPLE EMBODIMENTS

Some embodiments disclosed herein generally relate to virtual reality (VR) environments. More particularly, at least some embodiments relate to systems, hardware, software, computer-readable media, and methods, for creating and using virtual representations of various physical environments including, but not limited to, retail stores.

One or more example embodiments comprise methods and architectures for creating and using virtual environments. For the purposes of illustration, reference is made herein to a retail sales environment, but the scope of this application and of the claims is not so limited. One such method may be implemented in whole or in part by a system and method that comprise components such as, but not limited to, stereo lab cameras, sensors, radio beacons, AI models, procedural code, and data compression.

A method according to one embodiment may comprise operations including: using cameras, integrated with one or more AI models, and procedural code, to map an area of a physical space, such as a floor; performing an initial calibration of the cameras, based on movement of a human or other entity in the physical space; obtaining camera location and orientation information; gathering the camera location and orientation information, along with a virtual twin of the physical space, to create a virtual reality environment that includes virtual representations of the cameras that are located and oriented in the same way as in the physical space; and, gathering sensor data from the VR environment and processing that data. In an embodiment, data compression may be performed at any time(s) during and/or after collection of raw sensor data by the sensor(s).

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that sensor data collected by way of, and/or at the direction of, a VR environment may be fused in a customized way to suit the purposes of a particular application or set of circumstances. In an embodiment, one or more sensors may be selected, according to the needs of a particular application, for fusing of their data to create an application specific context. In an embodiment, raw and/or processed data may be compressed prior to storage and/or transmission. Various other aspects of one or more embodiments will be apparent from this disclosure.

### A. Context for One or More Embodiments for One Embodiment

The following is a discussion of aspects of a context for various embodiments. This discussion is not intended to limit the scope of the claims or this disclosure, or the applicability of the embodiments, in any way.

### A.1 Introduction

The retail industry is undergoing a profound transformation driven by rapidly changing consumer preferences, technological advancements, and increasing competition. To remain relevant and competitive in this dynamic landscape, retail enterprises face the challenge of finding innovative ways to engage customers, reduce transactional friction, enhance their shopping experiences, build their brands, and drive business transformation.

This disclosure encompasses a variety of areas. These include, but are not necessarily limited to: product visualization, virtual try-on, store optimization, consumer privacy, and interactive kiosks. By leveraging these technologies, retailers can cater to the increasing demands of tech-savvy consumers who seek convenient, immersive, and informative shopping encounters.

One or more embodiments may involve what are sometimes referred to as data network effects. For example, processes, infrastructure, and algorithms may be used to generate data network effects. A data network effect refers to the situation where the value of a system increases as more data accumulates within it. Realistic creation of data network effects may be attained by automatically capturing and processing contextualized. Data network effects are commonly leveraged in generative AI systems.

Generative AI requires large datasets that must be kept fresh through back-and-forth customer interactions, such as with a virtual assistant for example. To remain competitive, an AI operator must corral data, analyze it, offer predictions, and then seek feedback, such as from one or more users, to sharpen subsequent suggestions. The value of generative AI systems depends on the data that is automatically collected from users. The generative AI system performance—its ability to accurately predict and suggest—thus hinges on the economic principle referred to as data network effects.

Useful bits of data can be found everywhere, as an example, data may come from interactions with buyers, suppliers, and coworkers. A retailer, for example, could track what consumers looked at, what they placed in their cart, and what they ultimately paid for. These minute, seemingly trivial details can vastly improve the predictions of a generative AI system. In order for this data to be useful, it must be collected, compressed, and fused with other sensor solutions to provide context.

This data will not be sourced from humans pounding keyboards. It will, instead, be sensed via cameras and other high-resolution sensors and processed using “Distributed ML” or “Field AI” on tailored infrastructure.

### A.2 Example Aspects of Various Embodiments

It is expected that immersive technology will become a key enabler of business transformation because it enables humans to interact with business information persisted in datastores, machinery represented as digital twins, and artificial intelligence easily and as equals. This idea may be referred to as the immersive enterprise. This disclosure defines an immersive enterprise as a business that leverages immersive technology to perform business transformation. This idea is aligned with what some in the industry define as spatial computing.

Within spatial or immersive environments, the ability to model and improve business processes is only constrained by the processing capabilities of the underlying infrastructure. Thus, an embodiment can leverage real-world physics, or not. An embodiment may make a simulated environment track real time operations or replay the past. Historical analysis, exploratory planning, and new product introduction all become easier. Having these capabilities available to the average business has never happened before. It has the potential to dramatically improve businesses and to reduce transactional friction.

One example embodiment, discussed elsewhere herein, is focused on the retail vertical. However, it is noted that the concepts disclosed herein are largely transferable or applicable to other verticals.

### B. Detailed Discussion of Aspects of One or More Embodiments

### B.1 Introduction

One or more embodiments concern a variety of contexts and applications, aspects of which are disclosed in United States Patent Appl., atty. docket 16192.1163, entitled INFRASTRUCTURE TO COMPRESS AND FUSE SENSOR DATA, filed the same day herewith and incorporated herein in its entirety by this reference. Some contexts and applications include, but are not limited to, data compression such as in the context of virtual environments for example, business transformation through the utilization of interactive screens, retail store optimization using inventory robots, automated self-return systems, robotic carts, and implementing theft and fall detection measures, device optimization—which may entail camera and physical display calibration and management, and methods useful for creating multiple virtual representation of a physical space that individually and collectively generate actionable information.

To deal with the data deluge problem discussed earlier herein, and to gather valuable insights, one or more embodiments may involve the construction of virtual representations, or digital twin, of physical environments to facilitate tasks such as historical analysis, exploratory planning, optimization, and future training. This digital twin of physical spaces can combine a variety of different kinds of data gathering sensors, such as cameras and radio beacons, present in the space with their virtual counterparts. To ensure transferability of gained insights, it is important that the digital twin accurately matches the physical space with all sensors and coordinate systems appropriately calibrated to each other and to both, the physical and virtual.

### B.2 Overview

One or more embodiments may have various capabilities, although no embodiment is required to have any particular capability, or capabilities. Some example capabilities of one or more embodiments include, but are not limited to:
1. The ability to use stereo cameras which offer depth perception, enabling more advanced data processing.
2. The ability to combine depth information from multiple stereo cameras with AI (artificial intelligence) models and procedural code for more accurately mapping a physical space as well as the spatial (axis and rotational) information of all the cameras relative to each other.
3. The ability to use radio frequency beacons, such as UWB (ultrawideband) beacons, to identify individuals in a space.
4. The ability to align multiple coordinate axes with each other to combine the data from different sensors that represent different axes to generate a standard coordinate system in the virtual space.
5. The ability to generate actionable information in the virtual space by combining the outputs of multiple sensors.
6. The ability to use the standardized coordinate system to maintain uniformity and alignment between actionable information generated by Individual sets of sensors.
7. The ability to fuse data using local processing to develop contextual information from multiple sensors. As an example, camera and radio telemetry can be combined to identify particular users in a manner that meets local privacy requirements. This fused data may be particularly valuable for upstream generative AI systems.

### B.3 Detailed Discussion

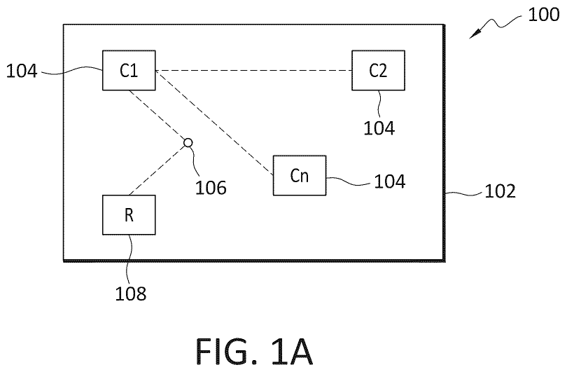

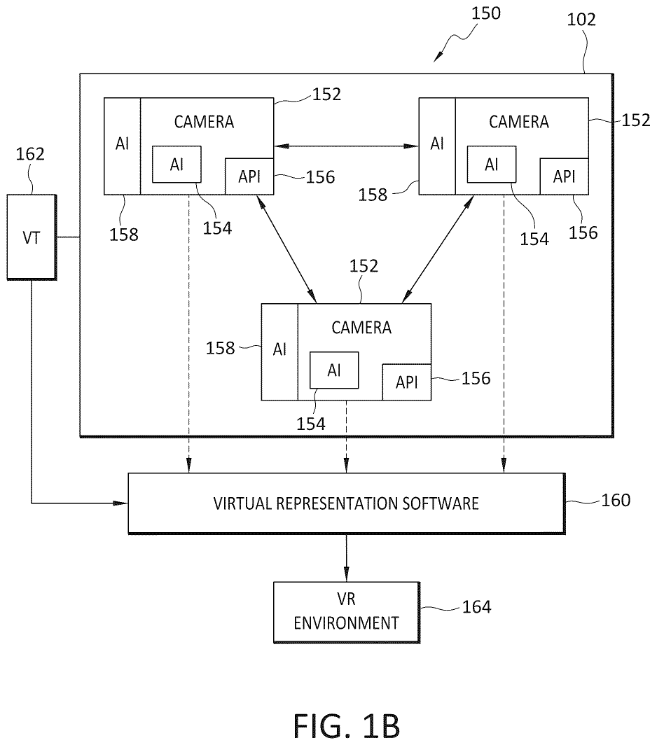

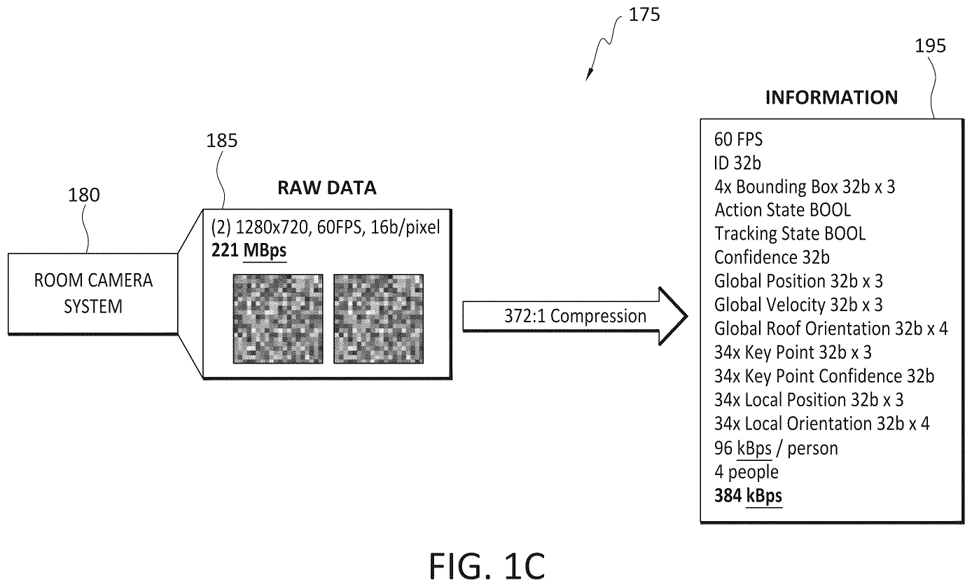

In an embodiment, various operations may be performed. With attention now to FIG. 1a, aspects of an example infrastructure 100 for an embodiment are disclosed. An embodiment may be implemented at least in part in a physical space 102, such as a room for example. The physical space 102 may be physically bounded, such as by walls for example, and/or may be arbitrarily defined using coordinates of a local, or global, coordinate system.

Within the physical space 102, various sensors, such as stereoscopic cameras 104 for example, may be deployed. Any number and type of sensors may be employed in a particular physical space. It is noted that as used herein, a ‘sensor’ embraces, but is not limited to, hardware, software, or a combination of hardware, operable to gather data concerning an environment where the sensor is deployed.

One or more of the cameras 104, and/or other sensors, may detect, and record information concerning, one or more entities 106 in the physical space 102. In an embodiment, an entity 106 may comprise a human, who may be moving around in the physical space 102, but the scope of this disclosure is not limited to human entities. Another example of an entity 106 is an autonomous vehicle, or other object. A camera 104, or other sensor(s), may comprise, or at least communicate with, one or more AI models, each of which may be specialized to perform particular functions concerning data gathered by the cameras 104 and/or by other sensors. Some examples of such AI models are discussed below. The physical space 102 may also comprise one or more radio beacons 108 that are operable to communicate with a mobile device of the entity 106.

Turning now to FIG. 1b, and with continued reference to the example of FIG. 1a, details are provided concerning an example architecture 150 and operations according to one embodiment. As shown, the architecture 150 may employ the elements of the infrastructure 100 disclosed in FIG. 1a, including cameras, and radio beacons, for example.

As shown in FIG. 1b, the cameras 152, which may comprise stereo lab cameras, may be integrated with respective instances of AI models 154 that run in the background using the APIs 156. The AI models 156, cameras 152, and procedural code may be used collectively to map, for example, [1] the floor of the physical space 102, [2] the axis and position of each camera 152 relative to the other cameras 152, and [3] the dimensions of the physical space 102.

In an embodiment, an initial calibration process may be performed involving an entity 106, such as a human for example, moving around in the physical space 102. This calibration process may comprise, for example, [1] using a depth sensing AI model, such as the AI model 156—that processes depth information obtained from the camera 152—to map the floor of the physical space 102, and [2] another AI model 158 extracts, from data gathered by the camera 152, global coordinates of the entity 106, while [3] procedural code maps those global coordinates to align the different cameras rotation and spatial information, as well as map the physical space 102.

After all of the cameras 152, and their overlapping respective views of the physical space 102 are calibrated, they can be imported into a virtual representation software 160 and their relative (in the physical space 102), as well as absolute (in a global coordinate system), positions are captured by the virtual representation software 160. As well, a 1:1 scale, or other scale, virtual twin (VT) 162 of the physical space, which may be generated with a suitable design tool, is imported into the virtual representation software 160. In this way, the cameras 104 placed in the physical space 102 exactly align with their respective positions in the VT 162 of the physical space 102 due to the calibration performed as described above.

Using the VT 162 and the camera 152 placement and location information, the virtual representation software 160 may then create, and output, a virtual reality (VR) environment 164 that mimics the physical space 102, and the sensors, such as the cameras 104, deployed in that physical space 102. That is, the VR 164 may be an exact—but virtual—replica of the physical space 102 and its components such that an entity 106, such as a human for example, may not be able to meaningfully distinguish between the VR environment 164 and the real environment of the physical space 102.

As noted earlier in the discussion of FIG. 1a, radio beacons 108 may be placed in the physical space 102 that are able to communicate with mobile devices of an entity 106 present in the physical space 102. An embodiment may thus obtain multiple coordinate systems from multiple sets of cameras 104, radio beacons 108, and any other additional sensors present in the physical space 102. These sensors may be aligned with each other using coordinate geometry so that the outputs of all these sensors result in the definition and implementation of a standard coordinate system.

In this way, the outputs of different sensors can be combined, or fused, to produce various useful outcomes. By way of illustration, an entity 106 may be identified using the radio beacon 108 telemetry and camera 104 outputs. As another example, an entity 106 may also be tracked as it moves from one set of camera 104 coordinates to another if those cameras are elements of the standardized model using a single system of coordinates.

With continued reference to the examples of FIGS. 1a and 1b, procedural code, which may comprise procedural programming, may be employed to perform a data compression process on the data gathered by the cameras 104 and/or other sensors such as the radio beacon(s) 108, an information extracted from the data gathered by the sensors, data that has been processed by the sensors, data processed by the AI models 154 and/or 158, and any data passed through—and processed by—the models 154 and/or 158. Thus, in the example of FIG. 1b, any data and/or metadata, whether raw or processed, may be compressed using the procedural code.

In one or more embodiments, various forms and implementations of data compression may be performed, and the scope of this disclosure is not limited to any particular type of data compression. In the illustrative, but non-limiting, context of data gathering by a camera, data compression may comprise, for example, reducing the number of frames per second captured, and/or retained, by the camera 104. Additionally, or alternatively, after still, video, and/or audio, data has been captured by the camera 104, the captured data may be processed by reducing the number of frames in a given data sample. For example, if raw data captured by the camera 105 has 60 frames per second, that data may be down-sampled to 20 frames per second, in effect, compressing that captured data. Data compression by reducing frames per second capture may be quite effective. For example, reducing capture from 60 frames per second to about 4 frames per second may result in a data amount reduction from 111 MBps to only 8 Bps.

Data compression according to an embodiment may have various benefits. For example, the compressed data may take up significantly less space in a data store. As well, it may take relatively less time to transmit the compressed data since the communication bandwidth needed may be significantly smaller than what would be needed for uncompressed data. Data compression may be performed on raw data collected by a sensor and/or after the raw data has been processed by the sensor and/or one or more other entities.

Turning next to the example of FIG. 1c, an example schema 175 according to one embodiment is disclosed in which data compression is performed using a room camera system 180. In particular, the room camera system 180, and/or other sensor(s), may capture data 185 in raw form. The raw data 185 may be compressed using various data compression techniques, examples of which are disclosed herein. Finally, various information, which may comprise data and metadata, collectively indicated at 195, may be extracted from the compressed, raw data 185. As shown, the information 195 may comprise a wide variety of things including, but not limited to, frame capture rate (60 fps), bounding box sizes and locations, position, movement, and orientation of an entity in a physical space, a headcount (4) for a physical space, and a compressed or reduced frame capture rate (384 kBps).

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

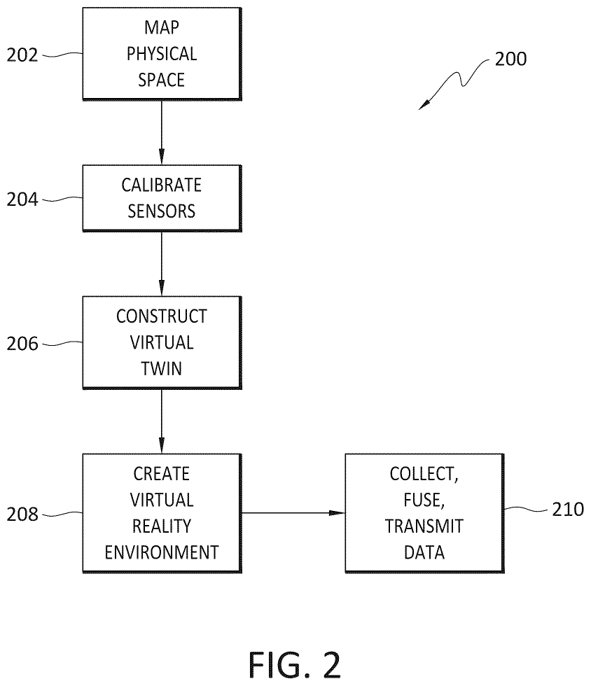

Directing attention now to FIG. 2, an example method 200 according to one embodiment is disclosed. In an embodiment, the method 200 may begin with the mapping 202, using one or more sensors such as cameras, a physical space. The mapping 202, which may produce a model, may comprise a two dimensional (2D) mapping, or a three-dimensional (3D) mapping.

The sensors may then be calibrated 204, such as by way of tracking a human or other entity in the physical space. The calibration process 204 may comprise generation of a coordinate system for the physical space, as well as extraction of the location of the human or other entity in a global coordinate system. As well, the calibration process 204 may be used to obtain the locations of each of the sensors in the coordinate system of the physical space.

Next, a virtual twin may be created 206 of the physical space. The creation 206 of the virtual twin may be performed using information obtained from the mapping 202. The virtual twin, along with the sensor location information, may then be used to create 208 a virtual reality (VR) environment that may be an exact-but virtual-replica of the physical space, including, for example, sensor locations and orientations.

In an embodiment, sensor data obtained from the VR environment and/or from the physical space, may be processed and handled in a variety of ways. For example, such sensor data may be collected, fused, stored, and transmitted, 210. As well, such sensor data may be compressed prior to storage and/or transmission of the data. In an embodiment, the sensor data may be provided to a generative AI system.

### D. Example Use Cases for One or More Embodiments

Following are some example use cases for one or more embodiments. These are provided only by way of illustration and are not intended to limit the scope of this disclosure, or of any claims, in any way.

### D.1 Example 1—Video Streaming and Surveillance

Video streaming platforms and surveillance systems often deal with large volumes of video data. Data compression, as may be implemented in an embodiment, can significantly reduce the bandwidth and storage requirements for that video data. In the example case of surveillance, this means that security cameras can continuously capture high-quality video while consuming less bandwidth and storage space, making it more cost-effective and efficient. Video streaming services can deliver content to users with faster load times and reduced buffering.

D.2 Example 2—IoT and sensor networks

Internet of Things (IoT) devices and sensor networks generate massive amounts of data, especially in applications like smart cities, environmental monitoring, and industrial automation. Data compression, as may be implemented in an embodiment, helps in transmitting this data over limited network bandwidth effectively. For instance, sensors collecting environmental data in remote areas can send compressed data to central servers without overburdening the available network resources. This technique makes IoT systems more scalable and cost-efficient.

### D.3 Example 3—Remote Sensing and Satellite Imaging

Remote sensing platforms, such as satellites and aerial drones, capture extensive imagery and data. Data compression, as may be performed in an embodiment, is useful in these scenarios to reduce the volume of data that needs to be transmitted to ground stations or stored on board at a sensor, satellite, or IoT device(s). This enables more efficient data transmission, reducing latency and making it feasible to gather and analyze data from remote locations. Researchers, environmental agencies, and disaster management teams can benefit from this by accessing timely and important information.

### E. Further Example Embodiments

Following are some further example embodiments. These are presented only by way of example and are not intended to limit the scope of this disclosure or the claims in any way.
Embodiment 1. A method, comprising: using cameras to map a physical space; calibrating the cameras, based on movement of a human or other entity in the physical space;
obtaining camera location and orientation information; creating, using a digital twin of the physical space and the camera location and orientation information, a virtual reality environment that includes virtual representations of the cameras that are located and oriented in the same way as in the physical space; collecting, from the virtual reality environment, data collected by the cameras; and processing the data.
Embodiment 2. The method as recited in claim 1, wherein the data collected by the cameras is then fused with other data collected by one or more sensors located in the physical space.
Embodiment 3. The method as recited in claim 1, wherein the data is compressed after its collection by the cameras.
Embodiment 4. The method as recited in claim 1, wherein the cameras comprise one or more stereo cameras, and the data collected by the cameras includes depth information.
Embodiment 5. The method as recited in claim 1, wherein the virtual reality environment is a virtual replica of the physical space that includes the cameras.
Embodiment 6. The method as recited in claim 1, wherein the data collected by one of the cameras is then fused with data gathered by a radio beacon that is deployed in the physical space.
Embodiment 7. The method as recited in claim 1, wherein a radio beacon is deployed in the physical space and is used in the calibrating of the cameras by determining a location, in the physical space, of the human or the other entity.
Embodiment 8. The method as recited in claim 1, wherein the data gathered by the cameras is used to generate a standard coordinate system in the virtual reality environment.
Embodiment 9. The method as recited in claim 1, wherein the physical space is mapped using respective instances of an artificial intelligence model associated with each of the cameras, and using procedural code.
Embodiment 10. The method as recited in claim 1, wherein an artificial intelligence model extracts, from the data collected by one of the cameras, global coordinates of the human or the other entity.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

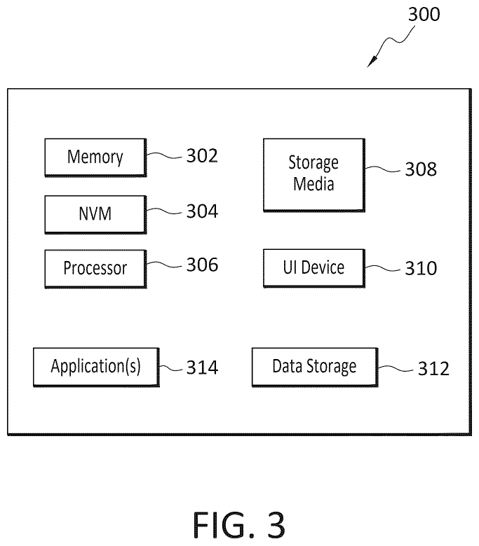

With reference briefly now to FIG. 3, any one or more of the entities disclosed, or implied, by FIGS. 1a-2, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
using cameras to map a physical space;
calibrating the cameras, based on movement of a human or other entity in the physical space;
obtaining camera location and orientation information;
creating, using a digital twin of the physical space and the camera location and orientation information, a virtual reality environment that includes virtual representations of the cameras that are located and oriented in the same way as in the physical space;
collecting, from the virtual reality environment, data collected by the cameras; and
processing the data.

2. The method as recited in claim 1, wherein the data collected by the cameras is then fused with other data collected by one or more sensors located in the physical space.

3. The method as recited in claim 1, wherein the data is compressed after its collection by the cameras.

4. The method as recited in claim 1, wherein the cameras comprise one or more stereo cameras, and the data collected by the cameras includes depth information.

5. The method as recited in claim 1, wherein the virtual reality environment is a virtual replica of the physical space that includes the cameras.

6. The method as recited in claim 1, wherein the data collected by one of the cameras is then fused with data gathered by a radio beacon that is deployed in the physical space.

7. The method as recited in claim 1, wherein a radio beacon is deployed in the physical space and is used in the calibrating of the cameras by determining a location, in the physical space, of the human or the other entity.

8. The method as recited in claim 1, wherein the data gathered by the cameras is used to generate a standard coordinate system in the virtual reality environment.

9. The method as recited in claim 1, wherein the physical space is mapped using respective instances of an artificial intelligence model associated with each of the cameras, and using procedural code.

10. The method as recited in claim 1, wherein an artificial intelligence model extracts, from the data collected by one of the cameras, global coordinates of the human or the other entity.

11. A non-transitory storage medium having stored therein instructions that are executable by one or more hardware processors to perform operations comprising:
using cameras to map a physical space;
calibrating the cameras, based on movement of a human or other entity in the physical space;
obtaining camera location and orientation information;
creating, using a digital twin of the physical space and the camera location and orientation information, a virtual reality environment that includes virtual representations of the cameras that are located and oriented in the same way as in the physical space;
collecting, from the virtual reality environment, data collected by the cameras; and
processing the data.

12. The non-transitory storage medium as recited in claim 11, wherein the data collected by the cameras is then fused with other data collected by one or more sensors located in the physical space.

13. The non-transitory storage medium as recited in claim 11, wherein the data is compressed after its collection by the cameras.

14. The non-transitory storage medium as recited in claim 11, wherein the cameras comprise one or more stereo cameras, and the data collected by the cameras includes depth information.

15. The non-transitory storage medium as recited in claim 11, wherein the virtual reality environment is a virtual replica of the physical space that includes the cameras.

16. The non-transitory storage medium as recited in claim 11, wherein the data collected by one of the cameras is then fused with data gathered by a radio beacon that is deployed in the physical space.

17. The non-transitory storage medium as recited in claim 11, wherein a radio beacon is deployed in the physical space and is used in the calibrating of the cameras by determining a location, in the physical space, of the human or the other entity.

18. The non-transitory storage medium as recited in claim 11, wherein the data gathered by the cameras is used to generate a standard coordinate system in the virtual reality environment.

19. The non-transitory storage medium as recited in claim 11, wherein the physical space is mapped using respective instances of an artificial intelligence model associated with each of the cameras, and using procedural code.

20. The non-transitory storage medium as recited in claim 11, wherein an artificial intelligence model extracts, from the data collected by one of the cameras, global coordinates of the human or the other entity.
